(19) United States
(12) Patent Application Publication
(10) Pub. No.: US 2022/0366880 A1
(43) Pub. Date: Nov. 17, 2022

(54) METHOD AND ELECTRONIC DEVICE FOR RECOGNIZING SONG, AND STORAGE MEDIUM

(71) Applicant: TENCENT MUSIC ENTERTAINMENT TECHNOLOGY (SHENZHEN) CO., LTD., Shenzhen (CN)

(72) Inventor: Lingcheng KONG, Shenzhen (CN)

(21) Appl. No.: 17/761,872

(22) PCT Filed: Dec. 17, 2019
(86) PCT No.: PCT/CN2019/125802

§ 371 Date: Mar. 18, 2022

(30) Foreign Application Priority Data
Sep. 19, 2019 (CN) 201910887630.8

(51) Int. Cl. G10H 1/00; G06F 17/14

(52) U.S. Cl. CPC G10H 1/0008; G06F 17/14; G10H 2240/141; G10H 2250/311; G10H 2250/235

(57) ABSTRACT

A method for recognizing a song, including: acquiring a target song segment and transforming the target song segment to generate a corresponding first spectrum map; generating a multi-dimensional first feature vector according to the first spectrum map and a preset neural network model; acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions; calculating similarities between the first feature vector and the second feature vectors, and determining a maximum similarity; and determining that the target song segment and a pre-stored song corresponding to the maximum similarity are different versions of the same song in response to the maximum similarity being greater than a preset threshold.

### CROSS-REFERENCE TO RELATED APPLICATION

This application is a U.S. national stage of international application No. PCT/CN2019/125802, filed on Dec. 17, 2019, which claims priority to the Chinese patent application No. 201910887630.8, filed to the China National Intellectual Property Administration (CNIPA) on Sep. 19, 2019 and entitled “METHOD AND APPARATUS FOR RECOGNIZING SONG, STORAGE MEDIUM AND ELECTRONIC DEVICE”. Both of these applications are herein incorporated by reference in their entireties.

### TECHNICAL FIELD

The present disclosure relates to the field of audio processing technologies and in particular relates to a method and an electronic device for recognizing a song, and a storage medium.

### BACKGROUND

Currently, a user can search for a song by inputting relevant keywords, such as a name or lyrics of a song. Or, when the user hears a favorite melody but does not know the name of the song, the user only needs to record a segment of the song that the user hears by a mobile phone, and then the user can recognize the song to which the segment belongs by the function of listening to and recognizing a song of music software.

### SUMMARY

An embodiment of the present disclosure provides a method for recognizing a song, including:

acquiring a target song segment and transforming the target song segment to generate a corresponding first spectrum map;

generating a multi-dimensional first feature vector according to the first spectrum map and a preset neural network model;

acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

calculating similarities between the first feature vector and the second feature vectors, and determining a maximum similarity; and

determining that the target song segment and a pre-stored song corresponding to the maximum similarity are different versions of the same song in response to the maximum similarity being greater than a preset threshold.

An embodiment of the present disclosure further provides a storage medium storing a plurality of instructions, and the instructions, when loaded by a processor, cause the processor to perform the following steps:

acquiring a target song segment, and transforming the target song segment to generate a corresponding first spectrum map;

generating a multi-dimensional first feature vector according to the first spectrum map and a preset neural network model;

acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

calculating similarities between the first feature vector and the second feature vectors, and determining a maximum similarity; and

determining that the target song segment and a pre-stored song corresponding to the maximum similarity are different versions of the same song in response to the maximum similarity being greater than a preset threshold.

An embodiment of the present disclosure further provides an electronic device for recognizing a song. The electronic device for recognizing a song includes a memory, a processor and a song recognition program stored in the memory and running on the processor, and the song recognition program, when executed by the processor, causes the processor to perform the following steps:

acquiring a target song segment and transforming the target song segment to generate a corresponding first spectrum map;

generating a multi-dimensional first feature vector according to the first spectrum map and a preset neural network model;

acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

calculating similarities between the first feature vector and the second feature vectors, and determining a maximum similarity; and

determining that the target song segment and a pre-stored song corresponding to the maximum similarity are different versions of the same song in response to the maximum similarity being greater than a preset threshold.

### BRIEF DESCRIPTION OF THE DRAWINGS

FIG. 1A is a schematic diagram of an application scenario of a method for recognizing a song according to an embodiment of the present disclosure;

FIG. 1B is a first flow chart of a method for recognizing a song according to an embodiment of the present disclosure;

FIG. 2A is a second flow chart of a method for recognizing a song according to an embodiment of the present disclosure;

FIG. 2B is a schematic structural diagram of a neural network of a method for recognizing a song according to an embodiment of the present disclosure;

FIG. 3A is a first schematic structural diagram of an apparatus for recognizing a song according to an embodiment of the present disclosure;

FIG. 3B is a second schematic structural diagram of an apparatus for recognizing a song according to an embodiment of the present disclosure;

FIG. 3C is a third schematic structural diagram of an apparatus for recognizing a song according to an embodiment of the present disclosure; and

FIG. 4 is a schematic structural diagram of an electronic device according to an embodiment of the present disclosure.

### DETAILED DESCRIPTION

The technical solutions of the embodiments of the present disclosure will be described clearly and completely with reference to the accompanying drawings in the embodiments of the present disclosure. It is apparent that the described embodiments are only part of embodiments of the present disclosure, rather than all of the embodiments. According to the described embodiments of the present disclosure, all of the other embodiments obtained by those skilled in the art without consuming any creative work shall fall within the protection scope of the present disclosure.

“Embodiment” mentioned in this text means that a particular feature, structure or characteristic described with reference to the embodiment may be included in at least one embodiment of the present disclosure. This phrase appearing in various positions of the description does not necessarily refer to the same embodiment, nor is it a separate or alternative embodiment that is exclusive with other embodiments. It is understood explicitly and implicitly by those skilled in the art that the embodiments described in the text can be combined with other embodiments.

In a traditional solution of listening to and recognizing a song, the name of the song is usually acquired by means of audio fingerprint retrieval, which can realize recognition of a recorded original song segment. But for a cover song, for example, a song segment hummed by the user himself/herself, the recognition accuracy for such song is very low.

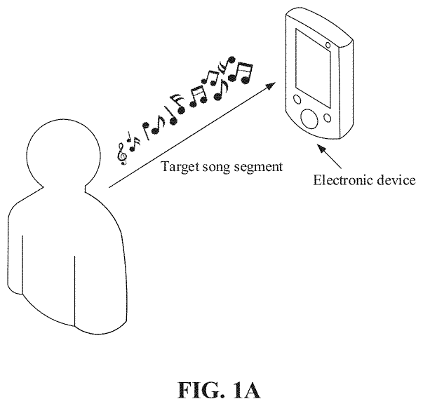

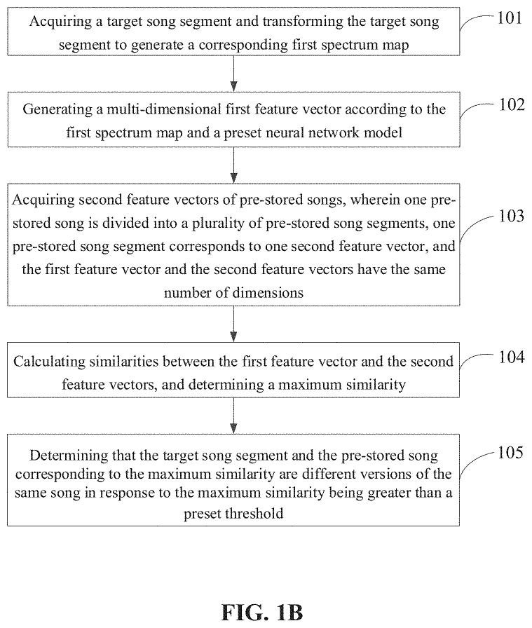

An embodiment of the present disclosure provides a method for recognizing a song, the executive subject of the method may be an apparatus for recognizing a song as provided by an embodiment of the present disclosure, or an electronic device integrated with the apparatus for recognizing a song, and the apparatus for recognizing a song may be implemented by means of hardware or software. The electronic device may be a smart phone, a tablet computer, a palm computer, a notebook computer, a desktop computer or the like. Referring to FIG. 1A, which is a schematic diagram of an application scenario of a method for recognizing a song according to an embodiment of the present disclosure, the electronic device collects a target song segment by a voice component, transforms the target song segment, generates a corresponding first spectrum map and generates a multi-dimensional first feature vector according to the first spectrum map and a preset neural network model, and the first feature vector may represent information contained in the target song segment. Next, a plurality of pre-stored song segments acquired by dividing each pre-stored song are acquired from a pre-stored song set. Each pre-stored song segment corresponds to one second feature vector and the way of generating the second feature vector according to the pre-stored song segments is the same as that of generating the first feature vector according to the target song segment, such that the second feature vector and the first feature vector have the same number of dimensions and the second feature vector may represent information contained in the pre-stored song segments. By calculating a similarity between the first feature vector and each of the second feature vectors, and determining a maximum similarity from a plurality of similarities, it can be determined that a pre-stored song segment corresponding to the maximum similarity is an original version of the target song segment, and it can be further determined that the target song segment and the pre-stored song segment corresponding to the maximum similarity are different versions of the same song. Then, the name of the pre-stored song may be output to realize listening to and recognizing a song for a cover song.

In an embodiment, a method for extracting a key frame is provided, which can be executed by an electronic device. As shown in FIG. 1B, the specific flow of the method for recognizing a song may be described as below.

In 101, a target song segment is acquired and transformed, and a corresponding first spectrum map is generated.

The solution of the present embodiment may be applied to a scenario of listening to and recognizing a song. For example, when a user hears a song that sounds good and wants to search for it; or, when a user wants to search for a song but the user remembers only lyrics but not the name of the song, the user can record a few lyrics hummed by himself/herself using an electronic device, and then start the function of listening to and recognizing a song of the electronic device to search for the song.

The target song segment is an audio segment input into the electronic device as a basis of the search. The mode of acquiring the target song segment is not specifically limited in the embodiments of the present disclosure. The target song segment may be recorded by the user's own humming or received from other terminals.

In some embodiments, a duration of the target song segment may be limited during recording. For example, after starting the function of listening to and recognizing a song of certain music software, the user starts to record the target song segment, the duration of which equals a preset duration, i.e., the recording is stopped when the recording duration reaches the preset duration.

The target song segment is acquired and then transformed to generate the corresponding first spectrum map. In some embodiments, the target song segment may be transformed in the following way: performing a short-time Fourier transform on the target song segment to generate the corresponding first spectrum map.

The short-time Fourier transform (STFT) is a mathematical transform related to Fourier transform, which is used to determine frequencies and phase positions of sine waves in local areas of a time-varying signal and is mostly used for analyzing a stable signal. Its basic principle is to select a time-frequency localized window function, divide a long time signal into short segments of the same length, and calculate Fourier transform on each short segment, i.e., Fourier spectrum. In the embodiments of the present disclosure, the short-time Fourier transform is performed on the target segment to acquire the first spectrum map, which is used as subsequent input data of a neural network model.

In some embodiments, transforming the target song segment to generate the corresponding first spectrum map includes: down-sampling the target song segment at a preset sampling rate; and transforming the down-sampled target song segment to generate a corresponding first spectrum map.

In order to improve the data processing speed, an original target song segment may be down-sampled at the preset sampling rate after the target song segment is acquired, for example, the original target song segment may be down-sampled to 16 KHz.

In some embodiments, down-sampling the target song segment at the preset sampling rate includes: determining whether a duration of the target song segment is greater than a preset duration; if yes, adjusting the duration of the target song segment to the preset duration; and down-sampling, at the preset sampling rate, the target song segment of the preset duration.

In addition to limiting the duration of the target song segment to the preset duration during recording of the target song segment, the duration of the target song segment may be adjusted after the target song segment is acquired, for example, prior to or after the down-sampling operation, if it is determined that the duration of the target song segment is greater than the preset duration, the target song segment is cut, e.g., the beginning part and the end part are cut off, such that a duration of the remaining part equals the preset duration.

In 102, a multi-dimensional first feature vector is generated according to the first spectrum map and a preset neural network model.

After the first spectrum map corresponding to the target song segment is acquired, it is input into a pre-trained neural network model for calculation so as to generate an n-dimensional first feature vector.

The neural network model proposed in the embodiments of the present disclosure extracts the first feature vector from the spectrum map using a convolutional neural network together with a dividing-and-encoding network. In the embodiments of the present disclosure, the neural network model includes the convolutional neural network and the dividing-and-encoding network, and its specific network structure is that the convolutional neural network includes 10 convolutional neural network blocks connected to divide-and-encode blocks, and each convolutional neural network block has two two-dimensional convolution kernels of 1×3 and 3×1. A sample song segment having a duration equal to the preset duration may be used for extracting the spectrum map, and the extracted spectrum map may be input into the preset neural network model for training so as to determine model parameters.

In some embodiments, generating the multi-dimensional first feature vector according to the first spectrum map and the preset neural network model includes: inputting the first spectrum map into the neural network model, and performing a convolution operation in the convolutional neural network to generate a feature tensor; and encoding the feature tensor according to the dividing-and-encoding network to generate a multi-dimensional first feature vector.

After the convolution operation on the first spectrum map by the convolutional neural network, one feature tensor, e.g., a two-dimensional feature matrix, is acquired. The feature tensor is input into the divide-and-encode blocks for processing, data output by the convolutional neural network is flattened into one-dimensional data, and the one-dimensional data is divided into n parts, for example, n=128. Each part is connected by a fully-connected layer and output to an output layer. Finally, the output layer outputs one 128-dimensional first feature vector.

In the embodiments of the present disclosure, one n-dimensional first feature vector is acquired from each segment of a song by means of machine learning, and whether song segments corresponding to the two vectors belong to the same song or different versions of the same song may be determined by the similarity between the vectors, such that not only an original song but also a cover song can be recognized, which can be well applied to the occasion of listening to and recognizing a song with high recognition accuracy. Furthermore, in the embodiments of the present disclosure, one n-dimensional first feature vector is acquired from each segment of a song by means of machine learning, which can not only increase the quantity of information of a feature, but also enhance the robustness of the algorithm. Moreover, high-dimensional audio data can be transformed into low-dimensional feature vectors, meanwhile, the similarity of the high-dimensional data can be kept consistent with that of the low-dimensional vectors, and further, the similarity of song segments can be determined by measuring the similarity of the low-dimensional feature vectors, thus reducing the complexity of calculation. In addition, the algorithm of listening to and recognizing a song proposed in the embodiments of the present disclosure can be applied to a real-time recognition system, i.e., real-time recognition can be performed while a song is covered. However, for some traditional cover recognition algorithms, it is often necessary to input the entire song for recognition, which can only be used for offline recognition.

In 103, second feature vectors of pre-stored songs are acquired, one pre-stored song is divided into a plurality of pre-stored song segments, one pre-stored song segment corresponds to one second feature vector, and the first feature vector and the second feature vectors have the same number of dimensions.

A pre-stored song set is built in advance, and a plurality of pre-stored songs are stored in the pre-stored song set. Each pre-stored song is divided into a plurality of pre-stored song segments. A duration of each pre-stored song segment may be divided according to a preset duration, e.g., the preset duration is set to 10 s. For example, a song with a duration of 240 s may be divided into 24 pre-stored song segments with a duration of 10 s according to the preset duration of 10 s. For each pre-stored song segment, the second feature vectors may be extracted in advance in the same manner as that of extracting the first feature vector from the target song segment, the second feature vectors are associated with the corresponding pre-stored song segments and the corresponding pre-stored song, and the second feature vectors, corresponding pre-stored song segments and corresponding pre-stored song are associated and then stored in the pre-stored song set.

In some embodiments, the method further includes the following steps.

In a1, a pre-stored song is acquired and down-sampled at a preset sampling rate.

In a2, the down-sampled pre-stored song is divided into a plurality of pre-stored song segments with a preset duration.

In a3, a short-time Fourier transform is performed on the pre-stored song segments to generate corresponding second spectrum maps.

In a4, second feature vectors are generated according to the second spectrum maps and the neural network model and are associated with the pre-stored song segments and the pre-stored song, and the second feature vectors, pre-stored song segments and the pre-stored song are associated and then stored in the pre-stored song set.

The second feature vectors corresponding to each pre-stored song are acquired by processing all the pre-stored songs in a song library as described above so as to build the pre-stored song set.

In 104, similarities between the first feature vector and the second feature vectors are calculated, and a maximum similarity is determined.

In 105, in response to the maximum similarity being greater than a preset threshold, it is determined that the target song segment and a pre-stored song corresponding to the maximum similarity are different versions of the same song.

During recognition of the target song segment, the first feature vector of the target song segment is acquired according to the aforementioned process, the similarity between the first feature vector and each of the second feature vectors is calculated, and the maximum similarity is determined from the plurality of similarities which are acquired from calculation.

Euclidean distances between the first feature vector and the second feature vectors are calculated, and the similarities between the first feature vector and the second feature vectors are determined according to the Euclidean distances. The smaller the Euclidean distance is, the greater the similarity is. For example, the Euclidean distance L is obtained by calculation, and 1/L is taken as the similarity. The size of a preset region is an empirical value and may be determined according to multiple simulation experiments.

Alternatively, in other embodiments, the similarities between the first feature vector and the second feature vectors may be calculated in other ways, e.g., cosine similarities are calculated. The cosine similarity itself can represent the similarities between the first feature vector and the second feature vectors, and the value range of the cosine similarity is (−1,1). The closer the calculated cosine similarity is to 1, the more similar it is. Alternatively, the similarities between the first feature vector and the second feature vectors may also be calculated by calculating a dynamic time warping (DTW) distance.

In response to the maximum similarity being greater than the preset threshold, the pre-stored song segment corresponding to the maximum similarity and the pre-stored song to which the pre-stored song segment belongs are determined, and it can be determined that the target song segment input by the user and the pre-stored song are different versions of the same song, i.e., the target song segment is a cover version of the pre-stored song. On an occasion of searching for a song, or listening to and recognizing a song, the name of the song or a search result is output for the user to play the song based on the search result.

The maximum similarity may be one maximum similarity or a plurality of maximum similarities. For example, three maximum similarities are determined from the plurality of calculated similarities. In this way, a plurality of songs are also found finally. For example, when one song has different versions sung by several singers, the songs sung by these different singers can be found.

In specific implementation, the present disclosure is not limited by the execution order of the described steps, and certain steps may also be performed in other sequences or simultaneously in the case of causing no conflict.

As mentioned above, in the method for recognizing a song according to the embodiment of the present disclosure, the target song segment is acquired and then transformed to generate the corresponding first spectrum map; the multi-dimensional first feature vector is generated according to the first spectrum map and the preset neural network model, and the first feature vector may represent information contained in the target song segment; and the second feature vectors of the pre-stored songs are acquired, each pre-stored song in the pre-stored song set is divided into a plurality of pre-stored song segments, one pre-stored song segment corresponds to one second feature vector, and the first feature vector and the second feature vectors have the same number of dimensions. The pre-stored song segment closest to the target song segment is determined by calculating the similarities between the first feature vector and the second feature vectors. Since there are a plurality of pre-stored song segments in the pre-stored song set, a plurality of similarities may be calculated, and the maximum similarity may be determined from the plurality of similarities. In response to the maximum similarity being greater than the preset threshold, it can be determined that the target song segment and the pre-stored song corresponding to the maximum similarity are different versions of the same song. In this solution, high-dimensional audio data is transformed into low-dimensional feature vectors by the neural network model, and the similarity of the songs is determined by measuring the similarity of the low-dimensional feature vectors, which can not only increase the quantity of information of a feature, but also enhance the robustness of the algorithm of listening to and recognizing a song. Further, accurate recognition of a cover song is realized.

Based on the method described in the previous embodiments, a detailed explanation will be made below by examples.

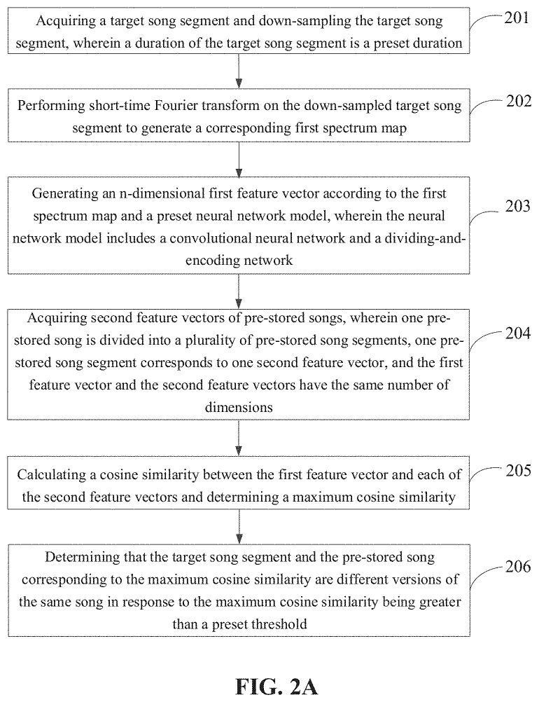

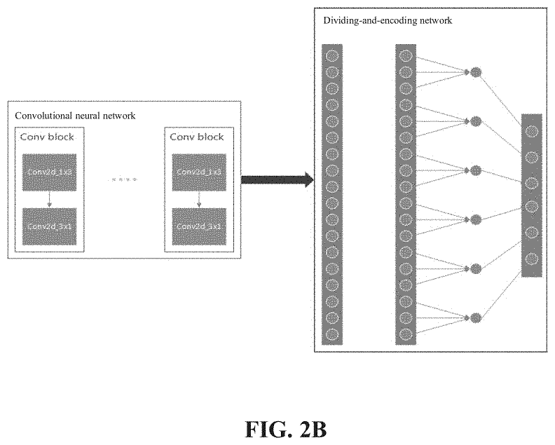

Referring to FIG. 2A, which is a second flow chart of a method for recognizing a song according to an embodiment of the present disclosure, the method includes the following steps.

In 201, a target song segment is acquired and down-sampled, wherein a duration of the target song segment is a preset duration.

The target song segment is an audio segment that is input into an electronic device as a basis of the search. The mode of acquiring the target song segment will not be specifically limited in the present embodiment. The target song segment may be recorded by the user's own humming or received from other terminals. For example, the user records the target song segment for a preset duration, e.g., 10 s, and then the target song segment is down-sampled to 16 KHz.

In 202, a short-time Fourier transform is performed on the down-sampled target song segment to generate a corresponding first spectrum map.

The electronic device performs a short-time Fourier transform on the target song segment, the duration of which is 10 s, selects a time-frequency localized window function, divides a long time signal into short segments of the same length, and calculates Fourier transform on each short segment. For example, a window length of the transform is 1024 and a step length of the transform is 512. The first spectrum map is acquired by performing the short-time Fourier transform on the target song segment according to these parameters. At this time, the first spectrum map should be a 513*312-dimensional image.

In 203, an n-dimensional first feature vector is generated according to the first spectrum map and a preset neural network model, wherein the neural network model includes a convolutional neural network and a dividing-and-encoding network.

The 513*312-dimensional first spectrum map is input into a pre-trained neural network model for feature extraction. Referring to FIG. 2B, which is a schematic structural diagram of a neural network model in the method for recognizing a song according to an embodiment of the present disclosure, the neural network model provided by the present embodiment consists of a convolutional neural network and a dividing-and-encoding network. The first spectrum map is input into the neural network model, and a convolution operation is performed in the convolutional neural network to generate a feature tensor; and the feature tensor is encoded according to the dividing-and-encoding network to generate a multi-dimensional first feature vector.

In some embodiments, the network structure of the neural network model may be that the convolutional neural network includes 10 convolutional neural network blocks, and each convolutional neural network block (conv block) has two two-dimensional convolution kernels of 1×3 and 3×1, such as conv2d_1×3 and conv2d_3×1 in FIG. 2B. The convolutional neural network is connected to the dividing-and-encoding network. Referring to FIG. 2B, four layers in the dividing-and-encoding network are an input layer, a data segmentation layer, a fully-connected layer and an output layer from left to right. Encoding the feature tensor according to the dividing-and-encoding network to generate the multi-dimensional first feature vector includes the following steps.

In b1, the feature tensor is input into the dividing-and-encoding network and transformed into one-dimensional data by the input layer, and the one-dimensional data is input into the data segmentation layer.

In b2, the one-dimensional data is divided into n parts by the data segmentation layer and each part is connected to the fully-connected layer.

In b3, after an operation in the fully-connected layer, the output layer outputs n eigenvalues, the n eigenvalues constitute an n-dimensional first feature vector, and n is a positive integer greater than 1.

The dividing-and-encoding network flattens the input feature tensor into one-dimensional data and then divides the one-dimensional data into n parts, each part is connected to the fully-connected layer, and the output layer outputs the n-dimensional first feature vector. Here, the first feature vector acquired by performing feature extraction on the 513*312-dimensional spectrum map is 128-dimensional.

An activation function of the convolutional neural network may be ELU, and an activation function of the fully-connected layer may be SIGMOD. In other embodiments, other functions may be used as required.

In other embodiments, the convolutional neural network and the dividing-and-encoding network may also be of other network structures, as long as they can perform feature extraction on the spectrum map and transform an extracted feature into a feature vector to represent information contained in the target song segment.

In 204, second feature vectors of pre-stored songs are acquired, wherein one pre-stored song is divided into a plurality of pre-stored song segments, one pre-stored song segment corresponds to one second feature vector, and the first feature vector and the second feature vectors have the same number of dimensions.

A group of second feature vectors are acquired from the pre-stored songs in the pre-stored song set in the following manner: acquiring a pre-stored song and down-sampling the pre-stored song at a preset sampling rate; dividing the down-sampled pre-stored song into a plurality of pre-stored song segments with a preset duration; performing a short-time Fourier transform on the pre-stored song segments to generate corresponding second spectrum maps; and generating second feature vectors according to the second spectrum maps and the neural network model, associating the second feature vectors with the pre-stored song segments and the pre-stored song, and storing the second feature vectors, pre-stored song segments and pre-stored song which are associated in the pre-stored song set.

The pre-stored song set is denoted as S={S1, S2 . . . SN}, in which N is the number of songs which are used for building a song library, and Si is a set of feature vectors of an i^{th} pre-stored song. In response to a duration of an i^{th} song being 240 s, Si contains 24 128-dimensional second feature vectors. A j^{th} second feature vector may be expressed as Sij.

In 205, a cosine similarity between the first feature vector and each of the second feature vectors is calculated and a maximum cosine similarity is determined.

A cover recognition query is performed on the target song segment, and an Euclidean distance between Q and each second feature vector Sij in S is calculated according to the first feature vector Q of the target song segment extracted in the above process.

In 206, in response to the maximum cosine similarity being greater than a preset threshold, it is determined that the target song segment and the pre-stored song corresponding to the maximum cosine similarity are different versions of the same song.

The smallest Euclidean distance L from all the second feature vectors Sij in S and a corresponding segment S0 are found. In response to L being less than a certain threshold H, it is determined that the target song segment Q is a cover version of the pre-stored song S0 in the pre-stored song set. At this time, the name of the pre-stored song S0 may be output to finish listening to and recognizing a song.

It should be noted that the numbers involved in the above embodiments, such as the window length and the step length in short-time Fourier transform, the preset duration of the song segments and the sampling rate, are all empirical values, which can be set to other values as required in practice of the solution.

As mentioned above, in the method for recognizing a song according to the embodiment of the present disclosure, after the target song segment is acquired, down-sampling and a short-time Fourier transform are performed on the target song segment to generate the corresponding first spectrum map; the multi-dimensional first feature vector is generated according to the first spectrum map and the preset neural network model, and the first feature vector may represent information contained in the target song segment; and the pre-stored song segment closest to the target song segment is determined by calculating the similarity between the first feature vector and each of the second feature vectors in the pre-stored song set, and the target song segment is determined to be a cover version of the pre-stored song corresponding to the maximum similarity. In this solution, high-dimensional audio data is transformed into low-dimensional feature vectors by the neural network model, and the similarity of the songs is determined by measuring the similarity of low-dimensional feature vectors, which can not only increase the quantity of information of a feature, but also enhance the robustness of the algorithm of listening to and recognizing a song. Further, accurate recognition of a cover song is realized.

In order to implement the above method, an embodiment of the present disclosure further provides an apparatus for recognizing a song, which can be specifically integrated in terminal devices such as a mobile phone and a tablet computer.

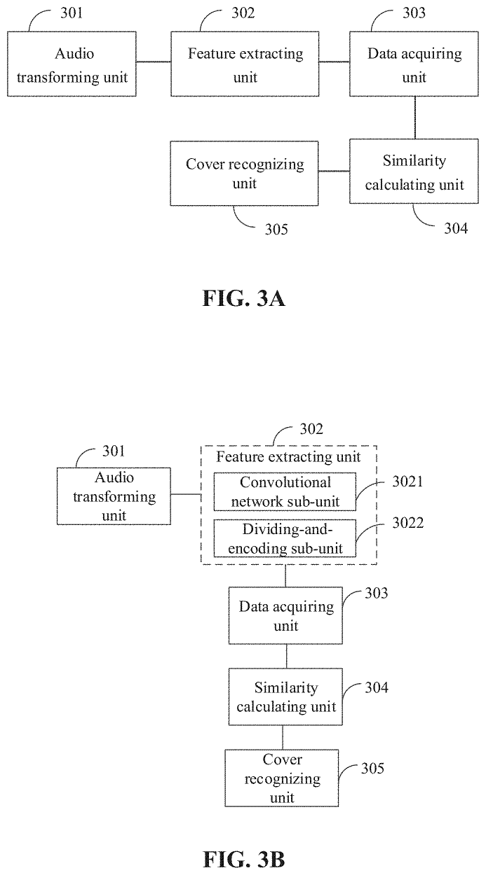

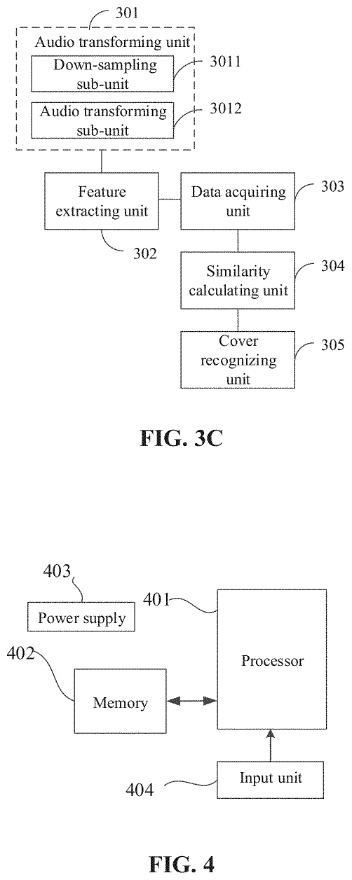

For example, as shown in FIG. 3A, which is a first schematic structural diagram of an apparatus for recognizing a song according to an embodiment of the present disclosure, the apparatus for recognizing a song may include an audio transforming unit 301, a feature extracting unit 302, a data acquiring unit 303, a similarity calculating unit 304 and a cover recognizing unit 305 as follows:

an audio transforming unit 301, configured to acquire a target song segment and transform the target song segment to generate a corresponding first spectrum map;

a feature extracting unit 302, configured to generate a multi-dimensional first feature vector according to the first spectrum map and a preset neural network model;

a data acquiring unit 303, configured to acquire second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

a similarity calculating unit 304, configured to calculate similarities between the first feature vector and the second feature vectors and determine a maximum similarity; and

a cover recognizing unit 305, configured to determine that the target song segment and the pre-stored song corresponding to the maximum similarity are different versions of the same song in response to the maximum similarity being greater than a preset threshold.

In some embodiments, the audio transforming unit 301 is further configured to: perform a short-time Fourier transform on the target song segment to generate a corresponding first spectrum map.

FIG. 3B is a second schematic structural diagram of an apparatus for recognizing a song according to an embodiment of the present disclosure. In some embodiments, a neural network model includes a convolutional neural network and a dividing-and-encoding network, and the feature extracting unit 302 includes:

a convolutional network sub-unit 3021, configured to input the first spectrum map into the neural network model and perform a convolution operation in the convolutional neural network to generate a feature tensor; and

a dividing-and-encoding sub-unit 3022, configured to encode the feature tensor according to the dividing-and-encoding network to generate a multi-dimensional first feature vector.

FIG. 3C is a third schematic structural diagram of an apparatus for recognizing a song according to an embodiment of the present disclosure. In some embodiments, the audio transforming unit 301 includes:

a down-sampling sub-unit 3011, configured to down-sample the target song segment at a preset sampling rate; and

an audio transforming sub-unit 3012, configured to transform the down-sampled target song segment to generate a corresponding first spectrum map.

In some embodiments, the down-sampling unit 3011 is further configured to:

determine whether a duration of the target song segment is greater than a preset duration;

if yes, adjust the duration of the target song segment to the preset duration; and

down-sample, at a preset sampling rate, the target song segment of the preset duration.

In some embodiments, the dividing-and-encoding network includes an input layer, a data segmentation layer, a fully-connected layer and an output layer, and the dividing-and-encoding sub-unit 3022 is further configured to:

input the feature tensor into the dividing-and-encoding network, transform the feature tensor into one-dimensional data by the input layer, and input the one-dimensional data into the data segmentation layer;

divide the one-dimensional data into n parts by the data segmentation layer, and connect each part to the fully-connected layer; and

after an operation in the fully-connected layer, output n eigenvalues by the output layer, wherein the n eigenvalues constitute an n-dimensional first feature vector, and n is a positive integer greater than 1.

In some embodiments, the apparatus for recognizing a song further includes a song library building unit, and the song library building unit is configured to:

acquire a pre-stored song and down-sample the pre-stored song at a preset sampling rate;

divide the down-sampled pre-stored song into a plurality of pre-stored song segments having a preset duration;

perform a short-time Fourier transform on the pre-stored song segments to generate corresponding second spectrum maps; and

generate second feature vectors according to the second spectrum maps and the neural network model, associate the second feature vectors with the pre-stored song segments and the pre-stored song, and store the second feature vectors, pre-stored song segments and pre-stored song which are associated in a pre-stored song set.

In some embodiments, the similarity calculating unit 304 is further configured to:

calculate Euclidean distances between the first feature vector and the second feature vectors, and determine similarities between the first feature vector and the second feature vectors according to the Euclidean distances, wherein the smaller the Euclidean distance is, the greater the similarity is.

During specific implementation, the above units can be implemented as independent entities, or they can be arbitrarily combined to be implemented as the same or several entities. A reference may be made to the previous method embodiments for the specific implementation of the above units, which will not be repeated herein.

It should be noted that the apparatus for recognizing a song according to the present embodiment and the method for recognizing a song in the above embodiments belong to the same concept, and any of the methods provided in the embodiments of the method for recognizing a song can be operated on the apparatus for recognizing a song. A reference may be made to the embodiments of the method for recognizing a song for details of the specific implementation process of the apparatus, which will not be repeated herein.

In the apparatus for recognizing a song according to the embodiment of the present disclosure, the audio transforming unit 301 acquires the target song segment and then transforms the target song segment to generate the corresponding first spectrum map; the feature extracting unit 302 generates the multi-dimensional first feature vector according to the first spectrum map and the preset neural network model, and the first feature vector may represent information contained in the target song segment; the data acquiring unit 303 acquires the second feature vectors of the pre-stored songs, each pre-stored song in the pre-stored song set is divided into a plurality of pre-stored song segments, one pre-stored song segment corresponds to one second feature vector, and the first feature vector and the second feature vectors have the same number of dimensions; and the similarity calculating unit 304 determines the pre-stored song segment closest to the target song segment by calculating the similarities between the first feature vector and the second feature vectors. Since there are a plurality of pre-stored song segments in the pre-stored song set, a plurality of similarities may be calculated, and the maximum similarity may be determined from the plurality of similarities. In response to the maximum similarity being greater than the preset threshold, the cover recognizing unit 305 may determine that the target song segment and the pre-stored song corresponding to the maximum similarity are different versions of the same song. In this solution, high-dimensional audio data is transformed into low-dimensional feature vectors by the neural network model, and the similarity of the songs is determined by measuring the similarity of the low-dimensional feature vectors, which can not only increase the quantity of information of a feature, but also enhance the robustness of the algorithm of listening to and recognizing a song. Further, accurate recognition of a cover song is realized.

An embodiment of the present disclosure further provides an electronic device. As shown in FIG. 4, which is a schematic structural diagram of an electronic device according to an embodiment of the present disclosure, the electronic device may include a processor 401 including one or more processing centers, a memory 402 including one or more computer-readable storage medium, a power supply 403, an input unit 404, etc. It will be understood by those skilled in the art that the structure of the electronic device shown in FIG. 4 does not constitute a limitation to the electronic device. The electronic device may include more or less components than those illustrated, or a combination of some components, or different component layouts.

The processor 401 is a control center of the electronic device, links all portions of the entire electronic device by various interfaces and circuits. By running or executing the software programs and/or the modules stored in the memory 402 and invoking data stored in the memory 402, the processor executes various functions of the electronic device and processes the data so as to wholly monitor the electronic device. Optionally, the processor 401 may include one or more processing centers. Preferably, the processor 401 may be integrated with an application processor and a modulation and demodulation processor. The application processor is mainly configured to process the operation system, a user interface, an application, etc. The modulation and demodulation processor is mainly configured to process radio communication. Understandably, the modulation and demodulation processor may not be integrated with the processor 401.

The memory 402 may be configured to store a software program and a module. The processor 401 executes various function applications and data processing by running the software programs and the modules, which are stored in the memory 402. The memory 402 may mainly include a program storage area and a data storage area. The program storage area can store an operation system, an application required by at least one function (e.g., an audio playback function and an image playback function). The data storage area may store data built based on the use of the electronic device. Moreover, the memory 402 may include a high-speed random access memory and may further include a nonvolatile memory, such as at least one disk memory, a flash memory or other volatile solid state memories. Correspondingly, the memory 402 may further include a memory controller to provide access to the memory 402 by the processor 401.

The electronic device may further include the power supply 403 for powering up all the components. Preferably, the power supply 403 is logically connected to the processor 401 through a power management system to manage charging, discharging, power consumption, etc. through the power management system. The power supply 403 may further include one or more of any of the following components: a direct current (DC) or alternating current (AC) power supply, a recharging system, a power failure detection circuit, a power transformer or inverter and a power state indicator.

The electronic device may further include an input unit 404, and the input unit 404 may be configured to receive input digital or character information and to generate keyboard, mouse, manipulator, optical or trackball signal inputs related to user settings and functional control.

Although not shown, the electronic device may further include a display unit and the like, which will not be repeated herein. Specifically, in this embodiment, the processor 401 in the electronic device will load executable files corresponding to one or more application programs into the memory 402 according to the following instructions, and the processor 401 will run the application programs stored in the memory 402 and may also achieve the following functions:

acquiring a target song segment and transforming the target song segment to generate a corresponding first spectrum map;

generating a multi-dimensional first feature vector according to the first spectrum map and a preset neural network model;

acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

calculating similarities between the first feature vector and the second feature vectors and determining a maximum similarity; and

determining that the target song segment and the pre-stored song corresponding to the maximum similarity are different versions of the same song in response to the maximum similarity being greater than a preset threshold.

In some embodiments, the processor 401 will run the application programs stored in the memory 402 and may also achieve the following function:

performing a short-time Fourier transform on the target song segment to generate a corresponding first spectrum map.

In some embodiments, the processor 401 will run the application programs stored in the memory 402, and may also achieve the following functions:

down-sampling the target song segment at a preset sampling rate; and

transforming the down-sampled target song segment to generate a corresponding first spectrum map.

In some embodiments, the processor 401 will run the application programs stored in the memory 402 and may also achieve the following functions:

determining whether a duration of the target song segment is greater than a preset duration;

if yes, adjusting the duration of the target song segment to the preset duration; and

down-sampling, at a preset sampling rate, the target song segment of the preset duration.

In some embodiments, the processor 401 will run the application programs stored in the memory 402 and may also achieve the following functions:

inputting the first spectrum map into the neural network model and performing a convolution operation in the convolutional neural network to generate a feature tensor; and

encoding the feature tensor according to the dividing-and-encoding network to generate a multi-dimensional first feature vector.

In some embodiments, the processor 401 will run the application programs stored in the memory 402, and may also achieve the following functions:

inputting the feature tensor into the dividing-and-encoding network, transforming the feature tensor into one-dimensional data by the input layer and inputting the one-dimensional data into the data segmentation layer:

dividing the one-dimensional data into n parts by the data segmentation layer, and connecting each part to the fully-connected layer, and

after an operation in the fully-connected layer, outputting n eigenvalues by the output layer, wherein the n eigenvalues constitute an n-dimensional first feature vector, and n is a positive integer greater than 1.

In some embodiments, the processor 401 will run the application programs stored in the memory 402, and may also achieve the following functions:

acquiring a pre-stored song and down-sampling the pre-stored song at a preset sampling rate;

dividing the down-sampled pre-stored song into a plurality of pre-stored song segments having a preset duration;

performing a short-time Fourier transform on the pre-stored song segments to generate corresponding second spectrum maps; and

generating second feature vectors according to the second spectrum maps and the neural network model, associating the second feature vectors with the pre-stored song segments and the pre-stored song, and storing the second feature vectors, pre-stored song segments and pre-stored song which are associated in a pre-stored song set.

In some embodiments, the processor 401 will run the application programs stored in the memory 402, and may also achieve the following function:

calculating Euclidean distances between the first feature vector and the second feature vectors, and determining similarities between the first feature vector and the second feature vectors according to the Euclidean distances, wherein the smaller the Euclidean distance is, the greater the similarity is.

It should be understood by those skilled in the art that all or part of the steps in various methods of the above embodiments can be completed by instructions or by controlling related hardware through instructions, and the instructions can be stored in a computer-readable storage medium and loaded and executed by a processor.

As mentioned above, in the electronic device according to the embodiment of the present disclosure, the target song segment is acquired and then transformed to generate the corresponding first spectrum map; the multi-dimensional first feature vector is generated according to the first spectrum map and the preset neural network model, and the first feature vector may represent information contained in the target song segment; and the second feature vectors of the pre-stored songs are acquired, each pre-stored song in the pre-stored song set is divided into a plurality of pre-stored song segments, one pre-stored song segment corresponds to one second feature vector, and the first feature vector and the second feature vectors have the same number of dimensions. The pre-stored song segment closest to the target song segment is determined by calculating the similarities between the first feature vector and the second feature vectors. Since there are a plurality of pre-stored song segments in the pre-stored song set, a plurality of similarities may be calculated, and the maximum similarity may be determined from the plurality of similarities. In response to the maximum similarity being greater than the preset threshold, it can be determined that the target song segment and the pre-stored song corresponding to the maximum similarity are different versions of the same song. In this solution, high-dimensional audio data is transformed into low-dimensional feature vectors by the neural network model, and the similarity of the songs is determined by measuring the similarity of the low-dimensional feature vectors, which can not only increase the quantity of information of a feature, but also enhance the robustness of the algorithm of listening to and recognizing a song. Further, accurate recognition of a cover song is realized.

Therefore, an embodiment of the present disclosure provides a storage medium storing a plurality of instructions, and the instructions, when loaded by a processor, cause the processor to perform any of the methods for recognizing a song according to the embodiments of the present disclosure. The storage medium may be a non-transitory computer readable storage medium. For example, the instructions may cause the processor to perform the following steps:

acquiring a target song segment, and transforming the target song segment to generate a corresponding first spectrum map;

generating a multi-dimensional first feature vector according to the first spectrum map and a preset neural network model;

acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;

calculating similarities between the first feature vector and the second feature vectors, and determining a maximum similarity; and

determining that the target song segment and the pre-stored song corresponding to the maximum similarity are different versions of the same song in response to the maximum similarity being greater than a preset threshold.

A reference may be made to the foregoing embodiments for specific implementation of the above operations, which will not be repeated herein.

The storage medium may include a read only memory (ROM), a random access memory (RAM), a magnetic disk or an optical disk.

Since the instructions stored in the storage medium may be intended to perform any of methods for recognizing a song according to the embodiments of the present disclosure, such that the beneficial effects achievable by any of the methods for recognizing a song can be realized, which is described in the previous embodiments and will not be repeated herein. The method and apparatus for recognizing a song and the storage medium provided by the embodiments of the present disclosure are described in detail above. The principles and implementations of the present disclosure are described by the specific examples in this context. The description of the above embodiments is only for helping to understand the method of the present disclosure and its core idea. Meanwhile, based on the idea of the present disclosure, there will be changes in the specific implementations and application scopes for those skilled in the art. In summary, the content of the description should not be construed as a limitation to the present disclosure.

1. A method for recognizing a song, comprising:
acquiring a target song segment and transforming the target song segment to generate a corresponding first spectrum map;
generating a multi-dimensional first feature vector according to the first spectrum map and a preset neural network model;
acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;
calculating similarities between the first feature vector and the second feature vectors, and determining a maximum similarity; and
determining that the target song segment and a pre-stored song corresponding to the maximum similarity are different versions of the same song in response to the maximum similarity being greater than a preset threshold.

2. The method for recognizing a song according to claim 1, wherein said transforming the target song segment to generate the corresponding first spectrum map comprises:
performing a short-time Fourier transform on the target song segment to generate a corresponding first spectrum map.

3. The method for recognizing a song according to claim 1, wherein said transforming the target song segment to generate the corresponding first spectrum map comprises:
down-sampling the target song segment at a preset sampling rate; and
transforming the down-sampled target song segment to generate a corresponding first spectrum map.

4. The method for recognizing a song according to claim 3, wherein said down-sampling the target song segment at the preset sampling rate comprises:
determining whether a duration of the target song segment is greater than a preset duration;
if yes, adjusting the duration of the target song segment to the preset duration; and
down-sampling, at a preset sampling rate, the target song segment of the preset duration.

5. The method for recognizing a song according to claim 1, wherein the preset neural network model comprises a convolutional neural network and a dividing-and-encoding network, and said generating the multi-dimensional first feature vector according to the first spectrum map and the preset neural network model comprises:
inputting the first spectrum map into the preset neural network model and performing a convolution operation in the convolutional neural network to generate a feature tensor; and
encoding the feature tensor according to the dividing-and-encoding network to generate a multi-dimensional first feature vector.

6. The method for recognizing a song according to claim 5, wherein the dividing-and-encoding network comprises an input layer, a data segmentation layer, a fully-connected layer and an output layer, and said encoding the feature tensor according to the dividing-and-encoding network to generate the multi-dimensional first feature vector comprises:
inputting the feature tensor into the dividing-and-encoding network, transforming the feature tensor into one-dimensional data by the input layer, and inputting the one-dimensional data into the data segmentation layer;
dividing the one-dimensional data into n parts by the data segmentation layer and connecting each part to the fully-connected layer; and
after an operation in the fully-connected layer, outputting n eigenvalues by the output layer, wherein the n eigenvalues constitute an n-dimensional first feature vector and n is a positive integer greater than 1.

7. The method for recognizing a song according to calm 1, further comprising:
acquiring a pre-stored song and down-sampling the pre-stored song at a preset sampling rate;
dividing the down-sampled pre-stored song into a plurality of pre-stored song segments having a preset duration;
performing a short-time Fourier transform on the pre-stored song segments to generate corresponding second spectrum maps; and
generating second feature vectors according to the second spectrum maps and the preset neural network model, associating the second feature vectors with the pre-stored song segments and the pre-stored song, and storing the second feature vectors, pre-stored song segments and pre-stored song which are associated in a pre-stored song set.

8. The method for recognizing a song according to claim 1, wherein said calculating the similarities between the first feature vector and the second feature vectors comprises:
calculating Euclidean distances between the first feature vector and the second feature vectors, and determining similarities between the first feature vector and the second feature vectors according to the Euclidean distances, wherein the smaller the Euclidean distance is, the greater the similarity is.

9-13. (canceled)

14. An electronic device for recognizing a song, comprising: a memory, a processor and a song recognition program stored in the memory and running on the processor, wherein the song recognition program, when executed by the processor, causes the processor to perform the following steps:
acquiring a target song segment and transforming the target song segment to generate a corresponding first spectrum map;
generating a multi-dimensional first feature vector according to the first spectrum map and a preset neural network model;
acquiring second feature vectors of pre-stored songs, wherein one pre-stored song is divided into a plurality of pre-stored song segments, one pre-stored song segment corresponds to one second feature vector, and the first feature vector and the second feature vectors have the same number of dimensions;
calculating similarities between the first feature vector and the second feature vectors, and determining a maximum similarity; and
determining that the target song segment and a pre-stored song corresponding to the maximum similarity are different versions of the same song in response to the maximum similarity being greater than a preset threshold.

15. The electronic device for recognizing a song according to claim 14, wherein the song recognition program, when executed by the processor, causes the processor to further perform the following step:
performing a short-time Fourier transform on the target song segment to generate a corresponding first spectrum map.

16. The electronic device for recognizing a song according to claim 14, wherein the song recognition program, when executed by the processor, causes the processor to further perform the following steps:
down-sampling the target song segment at a preset sampling rate; and
transforming the down-sampled target song segment to generate a corresponding first spectrum map.

17. The electronic device for recognizing a song according to claim 16, wherein the song recognition program, when executed by the processor, causes the processor to further perform the following steps:
determining whether a duration of the target song segment is greater than a preset duration;
if yes, adjusting the duration of the target song segment to the preset duration; and
down-sampling, at a preset sampling rate, the target song segment of the preset duration.

18. The electronic device for recognizing a song according to claim 14, wherein the preset neural network model comprises a convolutional neural network and a dividing-and-encoding network, and the song recognition program, when executed by the processor, causes the processor to perform the following steps:
inputting the first spectrum map into the preset neural network model and performing a convolution operation in the convolutional neural network to generate a feature tensor; and
encoding the feature tensor according to the dividing-and-encoding network to generate a multi-dimensional first feature vector.

19. The electronic device for recognizing a song according to claim 18, wherein the dividing-and-encoding network comprises an input layer, a data segmentation layer, a fully-connected layer and an output layer, and the song recognition program, when executed by the processor, causes the processor to perform the following steps:
inputting the feature tensor into the dividing-and-encoding network, transforming the feature tensor into one-dimensional data by the input layer, and inputting the one-dimensional data into the data segmentation layer;
dividing the one-dimensional data into n parts by the data segmentation layer, and connecting each part to the fully-connected layer; and
after an operation in the fully-connected layer, outputting n eigenvalues by the output layer, wherein the n eigenvalues constitute an n-dimensional first feature vector and n is a positive integer greater than 1.

20. The electronic device for recognizing a song according to claim 14, wherein the song recognition program, when executed by the processor, causes the processor to perform the following steps:
acquiring a pre-stored song, and down-sampling the pre-stored song at a preset sampling rate;
dividing the down-sampled pre-stored song into a plurality of pre-stored song segments having a preset duration;
performing a short-time Fourier transform on the pre-stored song segments to generate corresponding second spectrum maps; and
generating second feature vectors according to the second spectrum maps and the preset neural network model, associating the second feature vectors with the pre-stored song segments and the pre-stored song, and storing the second feature vector, pre-stored song segments and pre-stored song which are associated in a pre-stored song set.

21. The electronic device for recognizing a song according to claim 14, wherein the song recognition program, when executed by the processor, causes the processor to perform the following steps:
calculating Euclidean distances between the first feature vector and the second feature vectors, and determining similarities between the first feature vector and the second feature vectors according to the Euclidean distances, wherein the smaller the Euclidean distance is, the greater the similarity is.

22. A non-transitory storage medium storing a plurality of instructions, wherein the instructions, when loaded by a processor, cause the processor to perform the method for recognizing a song according to claim 1.
